(19) United States
(12) Patent Application Publication
(10) Pub. No.: US 2011/0276508 A1
(43) Pub. Date: Nov. 10, 2011

(54) SYSTEM AND METHOD FOR AN INFLUENCE BASED STRUCTURAL ANALYSIS OF A UNIVERSITY

(76) Inventors: SRIDHAR VARADARAJAN, Bangalore (IN); Srividya Gopalan, Bangalore (IN); Preethy Iyer, Bangalore (IN)

(21) Appl. No.: 12/873,715

(22) Filed: Sep. 1, 2010

(30) Foreign Application Priority Data
May 6, 2010 (IN) 1269/CHE/2010

(51) Int. Cl. G06Q 50/00

(52) U.S. Cl. 705/326

(57) ABSTRACT

An educational institution (also referred as a university) is rich with multiple kinds of data: students, faculty members, departments, divisions, and at university level. Relating and correlating this data at and across various levels help in obtaining a perspective about the educational institution. A structural representation captures the essence of all of the relationships in a unified manner and an important aspect of the relationship is the so-called “influence factor.” This factor indicates influencing effect of an entity over another entity, wherein the entities are a part of the structural representation. Given such a structural representation, a system and method that propagates the influence factors of the entities to arrive at a stable representation from the point of view of influences is discussed.

### CROSS-REFERENCE TO RELATED APPLICATION

The present application claims priority under 35 U.S.C. 119 of Indian Application No. 1269/CHE/2010, filed May 6, 2010, which is hereby incorporated herein by reference in its entirety.

### FIELD OF THE INVENTION

The present invention relates to the influence based structural analysis in general, and more particularly, automated analysis of structural representations. Still more particularly, the present invention relates to a system and method for automatic influence based structural analysis of a model graph associated with a university.

### BACKGROUND OF THE INVENTION

An educational institution (also referred as university) comprises of a variety of entities: students, faculty members, departments, divisions, labs, libraries, special interest groups, etc. University portals provide information about the universities and act as a window to the external world. A typical portal of a university provides information related to (a) Goals, Objectives, Historical information, and Significant milestones, of the university; (b) Profile of the Labs, Departments, and Divisions; (c) Profile of the Faculty members; (d) Significant Achievements; (e) Admission Procedures; (f) Information for Students; (g) Library; (h) On- and Off-Campus Facilities; (i) Research; (j) External Collaborations; (k) Information for Collaborators; (l) News and Events; (m) Alumni; and (n) Information Resources. Prospective students, candidates for exploring opportunities within the university, and funding agencies look towards this kind of portal to obtain information about and assess the university. While there are both objective and subjective measures for the assessment, the visitors to the portals would be more than satisfied if some information about these assessments is provide as part of the portals. For example, the students use this assessment information as part of the university portal to get a better understanding of the university they are exploring to enroll. Similarly, a funding agency gets a better picture of the university that they are planning to fund.

### DESCRIPTION OF RELATED ART

U.S. Pat. No. 7,162,431 to Guerra; Anthony J. (Hartsdale, N.Y.) for “Educational institution selection system and method” (issued on Jan. 9, 2007 and assigned to Turning Point for Life, Inc. (Hartsdale, N.Y.)) describes a system, method, and computer program product for selecting an educational institution, including determining selection criteria for an educational institution, including a location of the educational institution, a type and size of the educational institution, and an admission selectivity of the educational institution; and generating a list of one or more recommended schools satisfying the selection criteria, wherein the recommended schools satisfy predetermined freshman retention rates and graduation rates.

U.S. Pat. App. 20060265237 titled “System and method for ranking academic programs” by Martin; Lawrence B.; (Stony Brook, N.Y.) ; Olejniczak; Anthony J.; (Leipzig, Del.) filed on Mar. 27, 2006 describes a computer-implemented method for ranking a plurality of academic programs includes receiving a plurality of records corresponding to the plurality of academic programs, respectively, combining elements of the plurality of records to determine respective z-scores according to a predetermined metric, and ranking the plurality of academic programs according to the respective z-scores.

“Operators for Propagating Trust and their Evaluation in Social Networks” by Hang; Chung-Wei, Wang; Yonghong, and Singh, Munindar (appeared in International Conference on Autonomous Agents, Proceedings of The 8th International Conference on Autonomous Agents and Multiagent Systems—Volume 2 (2009)) describes an algebraic approach for the propagation of trust in a multiagent system.

“Stability of Graphs” by Demir; Bunyamin, Deniz; Ali, and Kocak; Sahin (appeared in The Electronic Journal of Combinatorics Vol. 16, No. 6 (2009)) describes a notion of graph stability to establish equivalence between two positively weighted graphs.

“Max-product for maximum weight matching: convergence, correctness and LP duality” by Bayati; Mohsen, Shah; Devavrat, and Sharma; Mayank (appeared in IEEE transactions on Information Theory, Vol. 54, No. 3, (2008)) describes, max-product “belief propagation”, an iterative, message-passing algorithm for finding the maximum a posteriori assignment of a discrete probability distribution specified by a graphical model.

The known systems do not address the issue of systematically utilizing the assessment at the elemental level and inter-element influences to assess an educational institution at various aggregated component levels. The present invention provides with a system and method for influence based structural analysis of an educational institute.

### SUMMARY OF THE INVENTION

The primary objective of the invention is to assess an educational institute at elemental and component level.

One aspects of the present invention is to obtain a university model graph of an educational institute that provides the structural representation of the educational institution.

Another aspect of the invention is to capture and utilize the influences at elemental level between elements of the university model graph.

Yet another aspect of the invention is to compute the assessment at elemental levels.

Another aspect of the invention is to propagate the elemental influences to assess at multiple aggregated component levels.

Yet another aspect of the invention is to define the university model graph as comprising of multiple nodes representing the educational institution at elemental and component levels.

Another aspect of the invention is to define the assessment at elemental levels as base score of the nodes associated with the university model graph.

Yet another aspect of the invention is to compute the best possible score called as peak score associated with the nodes of the university model graph.

In a preferred embodiment the present invention provides a system for structural analysis of a university to determine a plurality of assessments of said university at a plurality of levels, wherein said university comprises of a plurality of entities and said plurality of levels comprises of an element level and a component level, said system comprises:

means for obtaining of a university model graph of said university, wherein said university model graph comprises of a plurality of abstract nodes, a plurality of nodes, a plurality of abstract edges, and a plurality of edges, with each abstract node of said plurality of abstract nodes corresponding to an entity of said plurality of entities and each abstract node of said plurality of abstract nodes is associated with a model of a plurality of models, and a node of said plurality of nodes is connected to an abstract node of said plurality of abstract nodes through an abstract edge of said plurality of abstract edges, wherein said node represents an instantiation of an entity associated with said abstract node and said node is associated with an instantiated model, a base score, a present score, and a peak score, wherein said instantiated model is based on a model associated with said abstract node, and said base score is computed based on said instantiated model and is a value between 0 and 1, and a source node of said plurality of nodes is connected to a destination node of said plurality of nodes by a directed edge of said plurality of edges and said directed edge is associated with an influence factor, wherein said influence factor is a value between −1 and +1; (Refer to FIGS. 2, 2a, 2b, 3, and 4)

means for constructing a plurality of edge chains based on said university model graph;

means for performing of epsilon propagation based on said university model graph and said plurality of edge chains;

means for performing of core iteration based on said epsilon propagation and said plurality of edge chains;

means for determining of a characteristic value of a plurality of characteristic values based on said plurality of edge chains;

means for computing of a plurality of peak scores associated with said plurality of nodes of said university model graph based on said plurality of characteristic values; and

means for determining of said plurality of assessments based on said plurality of peak scores. (BASED ON FIGS. 6, 6a, and 6b)

### BRIEF DESCRIPTION OF THE DRAWINGS

FIG. 1 provides a typical assessment of a university.

FIG. 1a provides a partial list of entities of a university.

FIG. 2 depicts some concepts related to University Model Graph (UMG).

FIG. 2a provides an illustrative UMG.

FIG. 2b provides a brief description of the illustrative UMG.

FIG. 3 provides a brief about the notion of influence factor.

FIG. 4 describes information related to influence propagation and stability.

FIG. 5 describes an approach for UMG traversal and the core iteration.

FIG. 5a provides additional information related to the approach for UMG traversal and core iteration.

FIG. 6 provides an approach for UMG optimization.

FIG. 6a provides an assessment of an EI based on a UMG.

FIG. 6b provides an approach for EI assessment.

FIG. 7 depicts a portion of an Illustrative UMG.

FIG. 7a provides a portion of illustrative Base Scores.

FIG. 7b provides a portion of an illustrative Influence Matrix.

FIG. 7c depicts illustrative assessment based on Peak Score Computation.

FIG. 7d depicts additional results related to illustrative assessment based on Peak Score Computation.

### DETAILED DESCRIPTION OF THE PREFERRED EMBODIMENTS

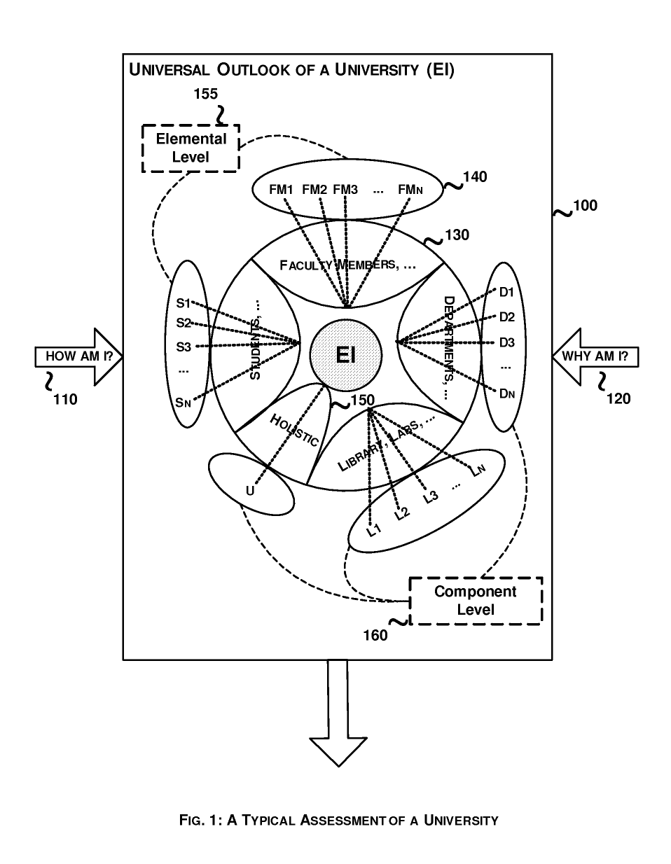

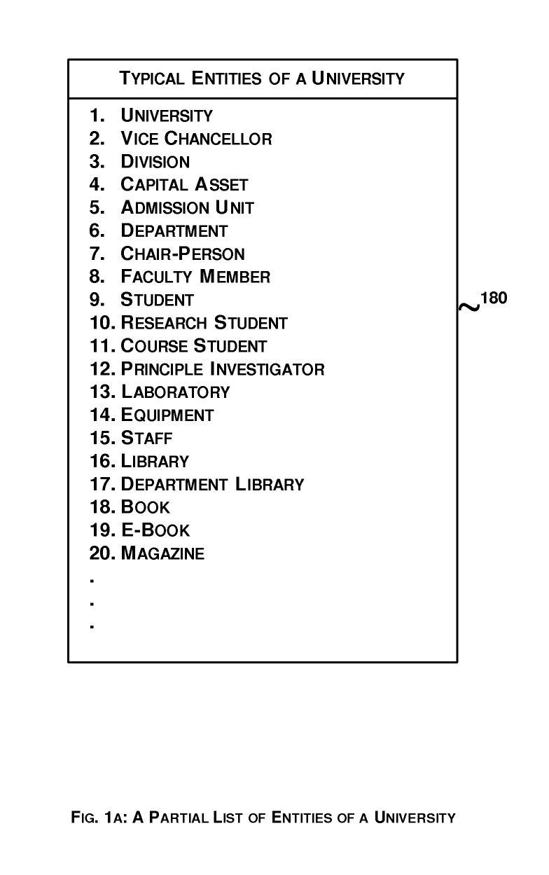

FIG. 1 provides a typical assessment of a university. An Educational Institution (EI) or alternatively, a university, is a complex and dynamic system with multiple entities and each interacting with multiple of other entities. The overall characterization of the EI is based on a graph that depicts these multi-entities multiple relationships. An important utility of such a characterization is to assess the state and status of the EI. What it means is that, in the context of the EI, it is helpful if every of the entities of the EI can be assessed. Assessment of the EI as a whole and the constituents at an appropriate level gives an opportunity to answer the questions such as “How am I?” and “Why am I?”. That is, the assessment of each of the entities and an explanation of the same can be provided. Consider a STUDENT entity: This is one of the important entities of the EI and in any EI, there are several instances of this entity that are associated with the students of the EI. The assessment can be at STUDENT level or at S1 (a particular student) level. 100 depicts the so-called “Universal Outlook of a University” and a system that provides such a universal outlook is capable of addressing “How am I?” (110) and “Why am I?” (120) queries. The FACULTY MEMBER entity (130) characterizes the set of all faculty members of FM1, FM2, . . . , FMn (140) of the EI. The holistic assessment (150) helps answer How and Why at university level. Observe that there are two distinct kinds of entities: One class of entities is at the so-called “Element” level (155)—this means that this kind of entities are at the atomic level as for as the university domain is concerned. On the other hand, there is a second class of entities at the so-called “Component” level (160) that accounts for remaining entities of the university domain all the way up to the University level.

FIG. 1a depicts a partial list of entities of a university. Note that a deep domain analysis would uncover several more entities and also their relationship with the other entities (180). For example, RESEARCH STUDENT is a STUDENT who is a part of a DEPARTMENT and works with a FACULTY MEMBER in a LABORATORY using some EQUIPMENT, the DEPARTMENT LIBRARY, and the LIBRARY.

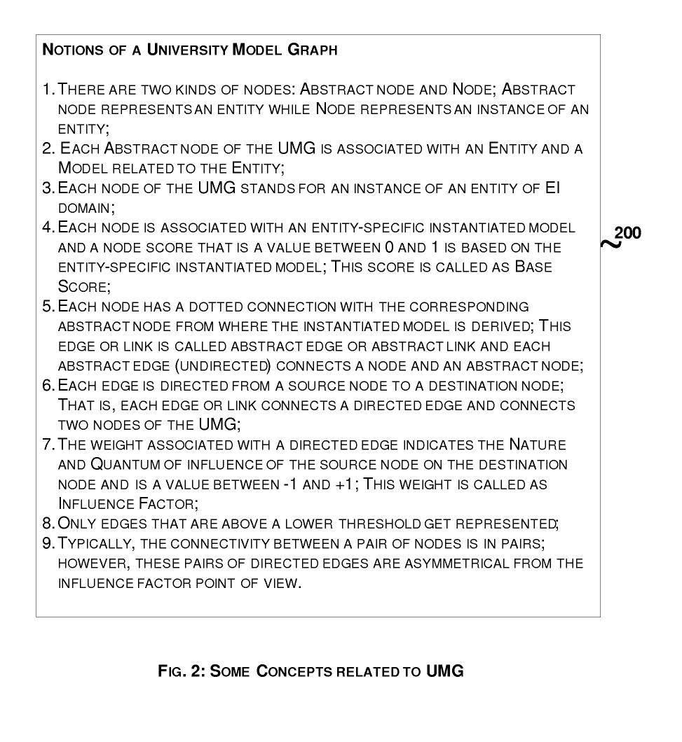

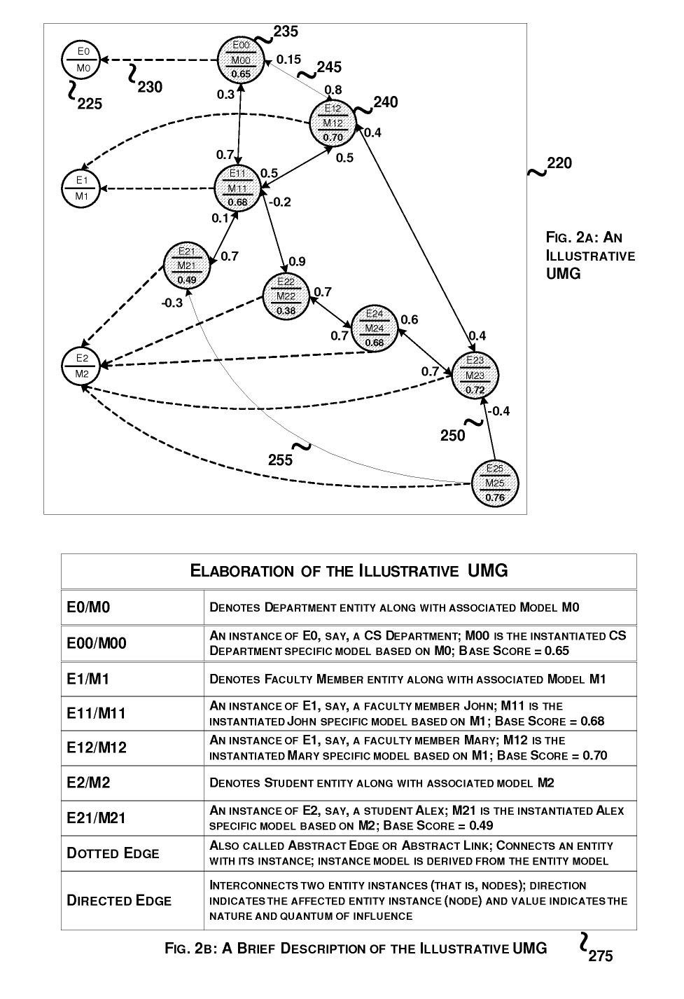

FIG. 2 provides some concepts related to University Model Graph (UMG) and means for obtaining UMG. A UMG is a typical graph that captures and relates the entities of the EI domain (200). Note that for the purposes of the present invention, a UMG, as described below, related to a university under consideration is available for structural analysis.

### Notions of a University Model Graph

1. There are two kinds of nodes: Abstract node and Node; Abstract node represents an entity while Node represents an instance of an entity;

2. Each Abstract node of the UMG is associated with an Entity and a Model related to the Entity;

3. Each node of the UMG stands for an instance of an entity of EI domain;

4. Each node is associated with an entity-specific instantiated model and a node score that is a value between 0 and 1 is based on the entity-specific instantiated model; This score is called as Base Score;

5. Each node has a dotted connection with the corresponding abstract node from where the instantiated model is derived; This edge or link is called abstract edge or abstract link and each abstract edge (undirected) connects a node and an abstract node;

6. Each edge is directed from a source node to a destination node; That is, each edge or link connects a directed edge and connects two nodes of the UMG;

7. The weight associated with a directed edge indicates the Nature and Quantum of influence of the source node on the destination node and is a value between −1 and +1; This weight is called as Influence Factor;

8. Only edges that are above a lower threshold get represented;

9. Typically, the connectivity between a pair of nodes is in pairs; however, these pairs of directed edges are asymmetrical from the influence factor point of view.

More particularly, there are several instances of each of the entities of the EI domain and the UMG captures the inter-relationship among the instance of these entities. Please note that in the sequel edge and link are used interchangeably.

FIG. 2a depicts an Illustrative UMG. The illustrative UMG (220) has several nodes: an abstract node (225) has a dotted link (abstract link) (230) with multiple nodes of the UMG and is associated with a pair: <E0, M0> wherein E0 is the entity under consideration and M0 is the associated model. The corresponding multiple nodes (235) of the UMG that are connected by a dotted link are the entity instances (nodes) and are also associated with a pair: <E00, M00> wherein E00 is an instance of E0 and M00 is an entity-specific instantiated model derived from M0. Further, the entity instance node is also associated with a node score called as base score as depicted. As part of the UMG, entity instances are connected by a directed link to indicate the influence factors. For example, the entity instance E00 and the entity instance E12 are connected by a pair of directed links (245): the link from E00 to E12 is with an influence factor of 0.8 and the link from E12 to E00 is with an influence factor of 0.15. However, note that not all the links need to be in pairs: observe this in the link between E25 and E23 wherein only the entity instance E25 influences E23. Also, observe a negative influence between E25 and E21 (255).

FIG. 2b provides a brief description of the illustrative UMG. The elaboration (275) includes providing of the various key aspects of the UMG and an illustrative description of the entities. For example, the following entities are involved: DEPARTMENT, CS DEPARTMENT, FACULTY MEMBER, and STUDENT.

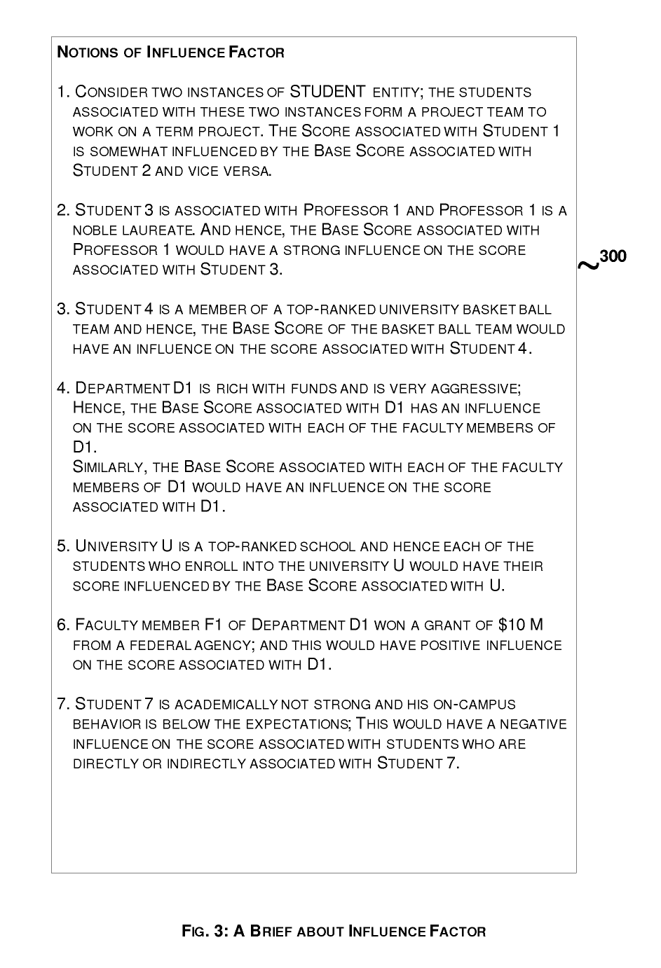

FIG. 3 depicts some of the aspects of Influence Factor.

### Notions of Influence Factor (300)

1. Consider two instances of STUDENT entity; the students associated with these two instances form a project team to work on a term project. The Score associated with Student 1 is somewhat influenced by the Base Score associated with Student 2 and vice versa.

2. Student 3 is associated with Professor 1 and Professor 1 is a noble laureate. And hence, the Base Score associated with Professor 1 would have a strong influence on the score associated with Student 3.

3. Student 4 is a member of a top-ranked university basket ball team and hence, the Base Score of the basket ball team would have an influence on the score associated with Student 4.

4. Department D1 is rich with funds and is very aggressive; Hence, the Base Score associated with D1 has an influence on the score associated with each of the faculty members of D1. Similarly, the Base Score associated with each of the faculty members of D1 would have an influence on the score associated with D1.

5. University U is a top-ranked school and hence each of the students who enroll into the university U would have their score influenced by the Base Score associated with U.

6. Faculty member F1 of Department D1 won a grant of $10 M from a federal agency; and this would have positive influence on the score associated with D1.

7. Student 7 is academically not strong and his on-campus behavior is below the expectations; This would have a negative influence on the score associated with students who are directly or indirectly associated with Student 7.

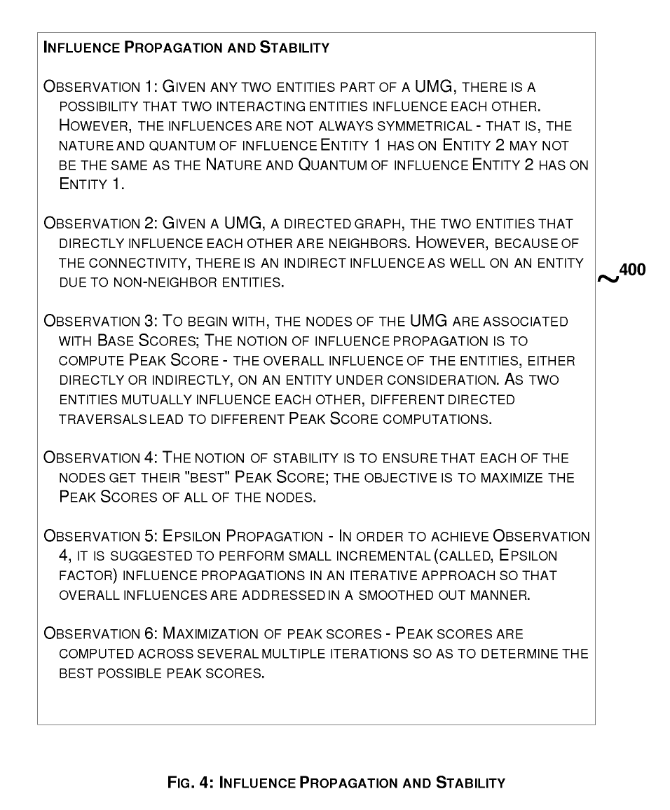

FIG. 4 depicts the notions of Influence Propagation and Stability.

### Influence Propagation and Stability (400)

Observation 1: Given any two entities part of a UMG, there is a possibility that two interacting entities influence each other. However, the influences are not always symmetrical—that is, the nature and quantum of influence Entity 1 has on Entity 2 may not be the same as the Nature and Quantum of influence Entity 2 has on Entity 1.

Observation 2: Given a UMG, a directed graph, the two entities that directly influence each other are neighbors. However, because of the connectivity, there is an indirect influence as well on an entity due to non-neighbor entities.

Observation 3: To begin with, the nodes of the UMG are associated with Base Scores; The notion of influence propagation is to compute Peak Score—the overall influence of the entities, either directly or indirectly, on an entity under consideration. As two entities mutually influence each other, different directed traversals lead to different Peak Score computations.

Observation 4: The notion of stability is to ensure that each of the nodes get their “best” Peak Score; the objective is to maximize the Peak Scores of all of the nodes.

Observation 5: Epsilon Propagation—In order to achieve Observation 4, it is suggested to perform small incremental (called, Epsilon factor) influence propagations in an iterative approach so that overall influences are addressed in a smoothed out manner.

Observation 6: Maximization of peak scores—Peak scores are computed across several multiple iterations so as to determine the best possible peak scores.

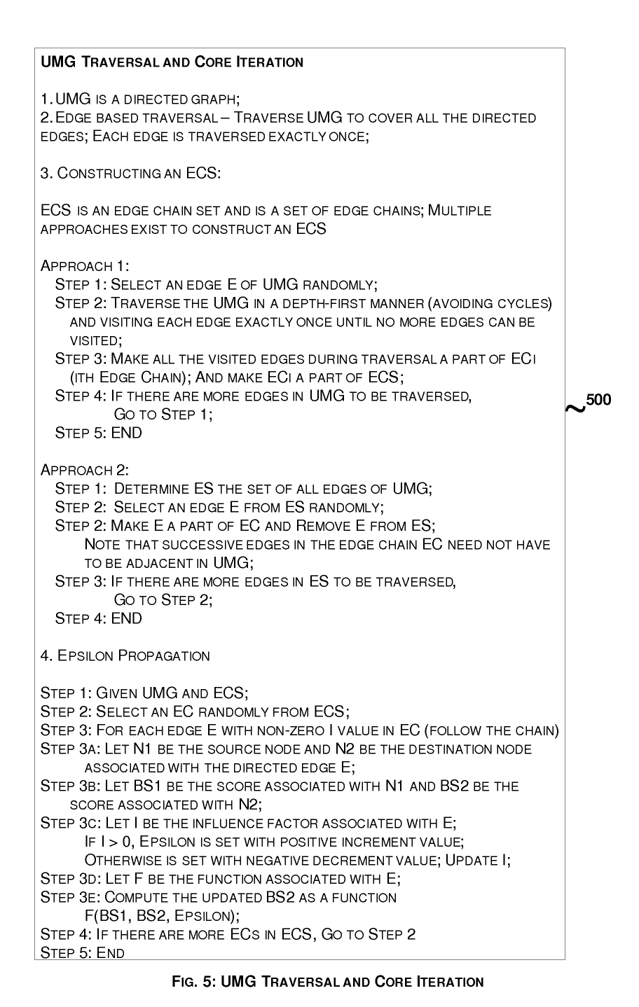

FIG. 5 depicts the steps involved in the UMG traversal and core iteration.

### UMG Traversal and Core Iteration (500)

1. UMG is a directed graph;

2. Edge based traversal—Traverse UMG to cover all the directed edges; Each edge is traversed exactly once;

3. Constructing an ECS:

ECS is an edge chain set and is a set of edge chains; Multiple approaches exist for designing means to construct an ECS.
Approach 1:
   Step 1: Select an edge E of UMG randomly;
   Step 2: Traverse the UMG in a depth-first manner (avoiding cycles) and visiting each edge exactly once until no more edges can be visited;
   Step 3: Make all the visited edges during traversal a part of ECi (ith Edge Chain); And make ECi a part of ECS;
   Step 4: If there are more edges in UMG to be traversed,
      Go to Step 1;
   Step 5: END
Approach 2:
   Step 1: Determine ES the set of all edges of UMG;
   Step 2: Select an edge E from ES randomly;
   Step 2: Make E a part of EC and Remove E from ES;
   Note that successive edges in the edge chain EC need not have to be adjacent in UMG;
   Step 3: If there are more edges in ES to be traversed,
      Go to Step 2;
   Step 4: END

4. Epsilon Propagation

Following steps can be carried out with the help of means for performing Epsilon Propagation:
Step 1: Given UMG and ECS;
Step 2: Select an EC randomly from ECS;
Step 3: For each edge E with non-zero I value in EC (follow the chain)
Step 3a: Let N1 be the source node and N2 be the destination node associated with the directed edge E;
Step 3b: Let BS1 be the score associated with N1 and BS2 be the score associated with N2;
Step 3c: Let I be the influence factor associated with E;
   If I>0, Epsilon is set with positive increment value;
   Otherwise is set with negative decrement value; Update I;
Step 3d: Let F be the function associated with E;
Step 3e: Compute the updated BS2 as a function F(BS1, BS2, Epsilon);
Step 4: If there are more ECs in ECS, Go to Step 2
Step 5: End

FIG. 5a provides additional steps related to UMG Traversal and Core Iteration.

### UMG Traversal and Core Iteration (Contd.) (550)

5. Means for performing Core Iteration carry out the following steps:
Step 1: Given UMG
Step 2: Construct ECS
Step 3: For each Edge Chain in ECS
Step 3a: If there are no edges in Edge Chain with Absolute of I value>Epsilon,
   Go To Step 3;
Step 3b: Perform Epsilon Propagation;
Step 3c: Go To Step 3a;
Step 4: END

6. Means for determining a Characteristic Value of ECS perform the following steps:
Step 1: Given UMG and ECS
Step 2: Perform Core Iteration based on UMG and ECS;
Step 3: Each node in UMG is associated with a score;
   To begin with, this score is called as Base Score;
   During the process of Incremental Influence propagation, the score associated is called as Present Score;
   On reaching stability, the score is called as Peak Score
Step 4: Characteristic value is the sum of Present Score associated with each node of UMG.

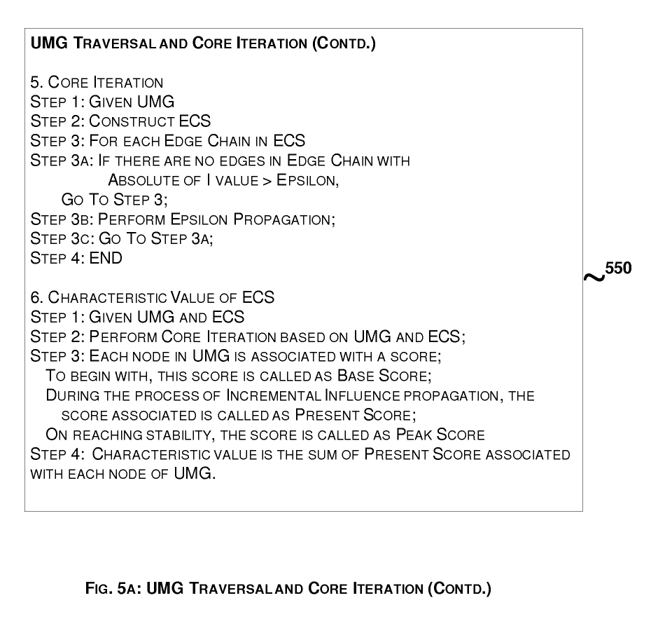

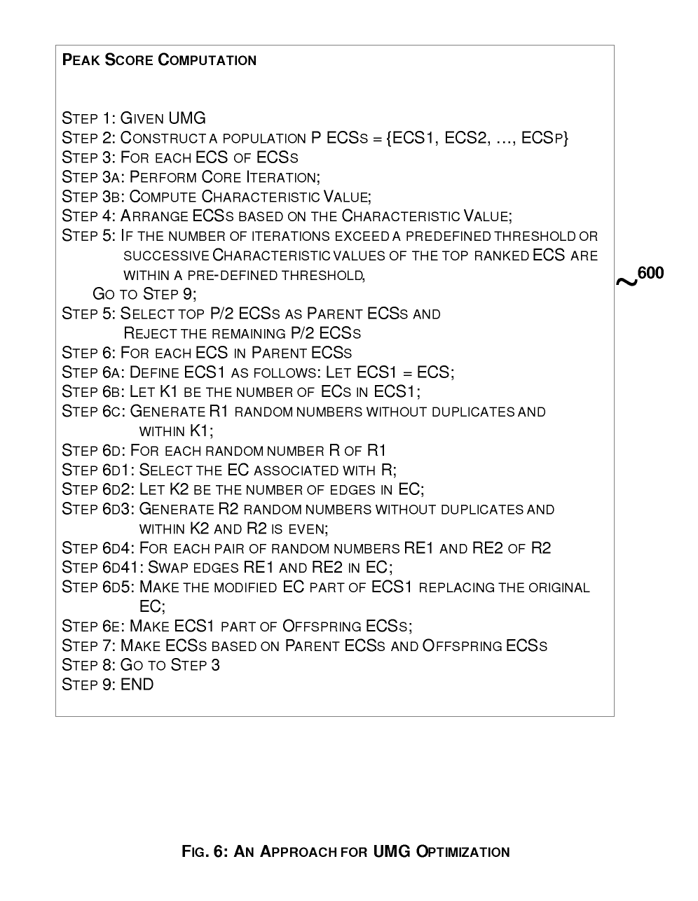

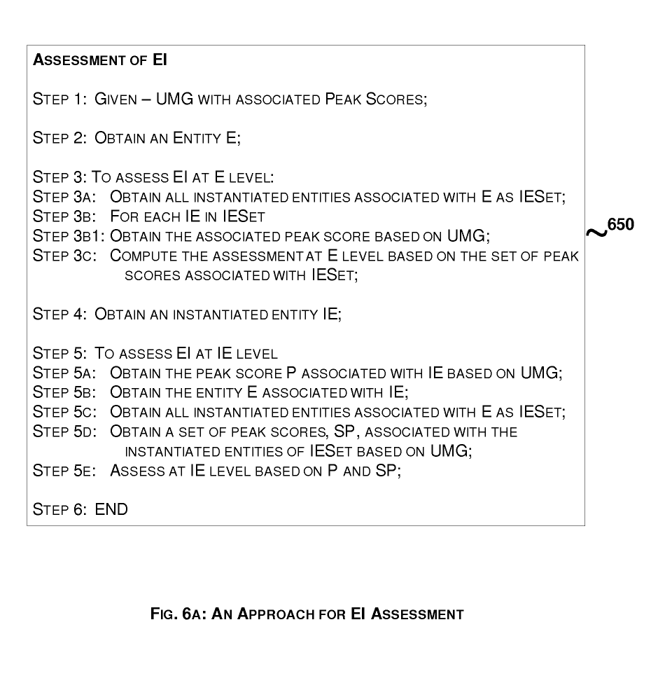

FIG. 6 provides an approach for UMG Optimization.

FIGS. 6, 6a, and 6b collectively provide means for determining a plurality of assessments based on peak scores.

Given a UMG, the objective is to determine the peak score associated with each of the nodes and this process is called as UMG optimization.

### Peak Score Computation (600)

Step 1: Given UMG

Step 2: Construct a population P ECSs={ECS1, ECS2, . . . , ECSp}

Step 3: For each ECS of ECSs

Step 3a: Perform Core Iteration;

Step 3b: Compute Characteristic Value;

Step 4: Arrange ECSs based on the Characteristic Value;

Step 5: If the number of iterations exceed a predefined threshold or successive Characteristic values of the top ranked ECS are within a pre-defined threshold,
Go to Step 9;

Step 5: Select top P/2 ECSs as Parent ECSs and
Reject the remaining P/2 ECSs

Step 6: For each ECS in Parent ECSs

Step 6a: Define ECS1 as follows: Let ECS1=ECS;

Step 6b: Let K1 be the number of ECs in ECS1;

Step 6c: Generate R1 random numbers without duplicates and within K1;

Step 6d: For each random number R of R1

Step 6d1: Select the EC associated with R;

Step 6d2: Let K2 be the number of edges in EC;

Step 6d3: Generate R2 random numbers without duplicates and within K2 and R2 is even;

Step 6d4: For each pair of random numbers RE1 and RE2 of R2

Step 6d41: Swap edges RE1 and RE2 in EC;

Step 6d5: Make the modified EC part of ECS1 replacing the original EC;

Step 6e: Make ECS1 part of Offspring ECSs;

Step 7: Make ECSs based on Parent ECSs and Offspring ECSs

Step 8: Go to Step 3

Step 9: END

FIG. 6a provides an assessment of an EI based on a UMG. The structural analysis of an EI (or a university) based on a UMG involves the following steps (630):

Step 1: Obtain an UMG associated with an EI;

Step 2: Compute Peak scores based on an optimized UMG;

Step 3: Based on the UMG associated with the computed peak scores, assess the various entities associated with the EI;

Step 4: END

FIG. 6b provides an approach for EI assessment. The assessment of EI at various levels is based on the computed peak scores that are associated with the various nodes of the university model graph. A high level description of the approach is provided below.

### Assessment of EI (650)

Step 1: Given—UMG with associated Peak Scores;

Step 2: Obtain an Entity E;

Step 3: To assess EI at E level:

Step 3a: Obtain all instantiated entities associated with E as IESet;

Step 3b: For each IE in IESet

Step 3b1: Obtain the associated peak score based on UMG;

Step 3c: Compute the assessment at E level based on the set of peak scores associated with IESet;

Step 4: Obtain an instantiated entity IE;

Step 5: To assess EI at IE level

Step 5a: Obtain the peak score P associated with IE based on UMG;

Step 5b: Obtain the entity E associated with IE;

Step 5c: Obtain all instantiated entities associated with E as IESet;

Step 5d: Obtain a set of peak scores, SP, associated with the instantiated entities of IESet based on UMG;

Step 5e: Assess at IE level based on P and SP;

Step 6: END

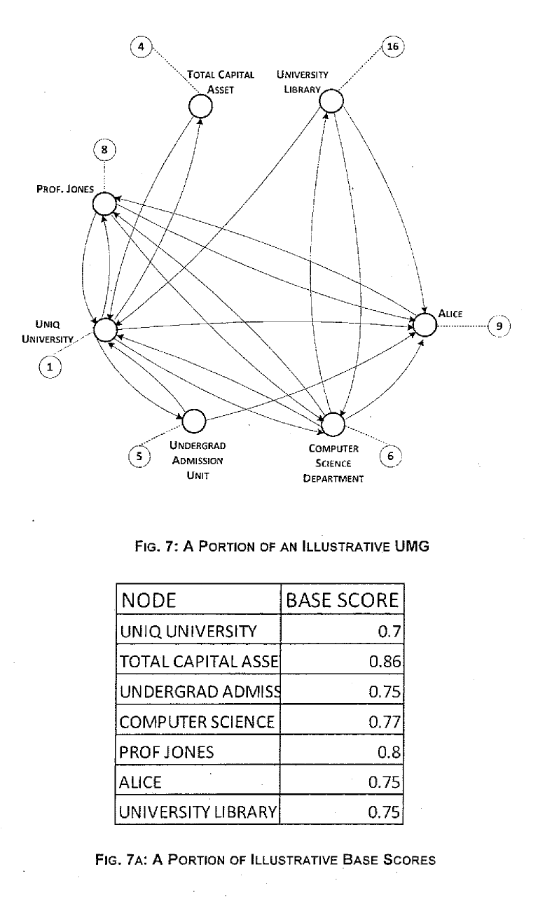

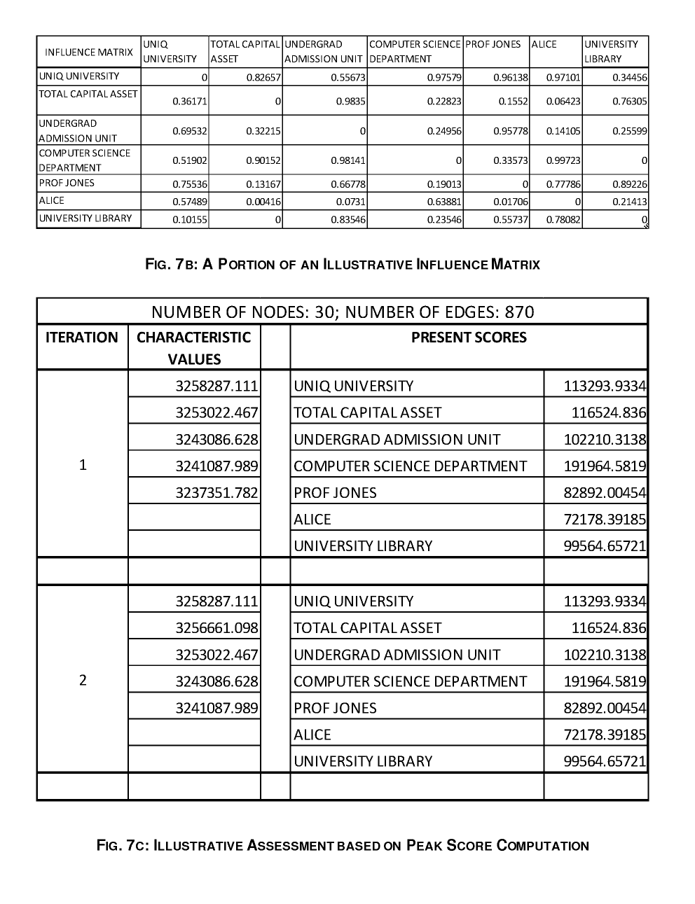

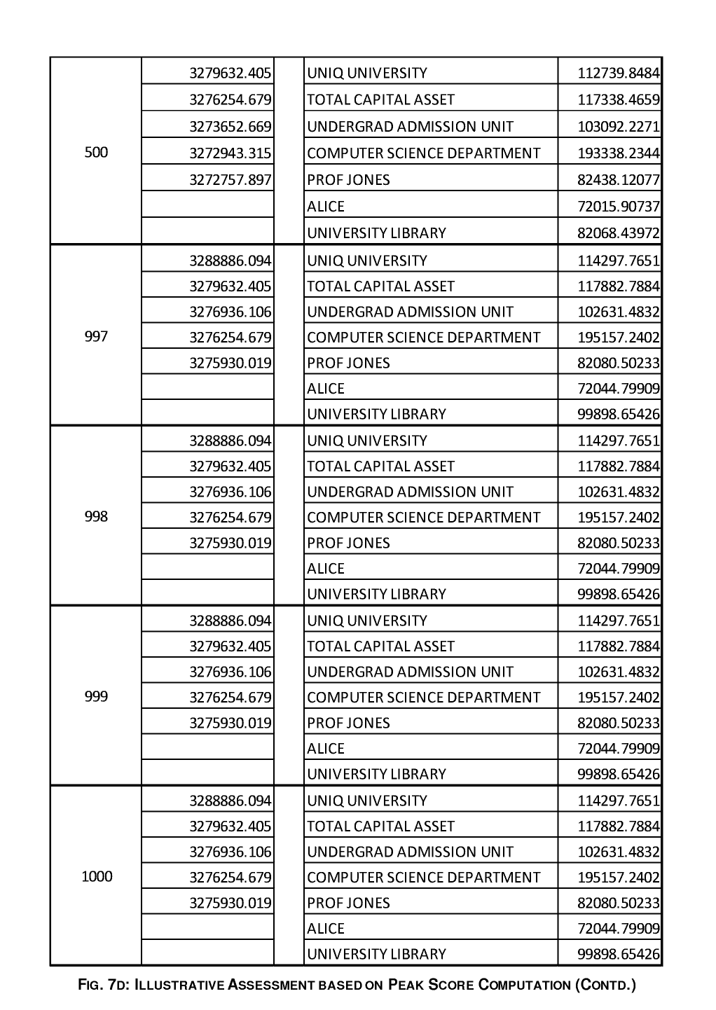

FIGS. 7, 7a, 7b, 7c, and 7d depict an illustrative assessment based on peak score computation. The first step in the assessment process of an educational institution is the construction of a UMG. A UMG is EI specific in the sense that the extent of detailing is based on the vastness of the EI and is also a design and operational decision. Two aspects are very important in a UMG: base scores and influence factors (I values). FIG. 7 depicts a portion of an illustrative UMG. Note that the nodes are connected using abstract edges to the abstract nodes and the numbers of the abstract nodes refer to the entities depicted in FIG. 1a.

Give such a UMG, FIG. 7a depicts a portion of the illustrative base scores associated with the nodes of the UMG. FIG. 7b provides a portion of the illustrative influence matrix.

And, finally, FIGS. 7c and 7d provide the intermediate and final results of the process of computation of peak scores of the nodes of the UMG. Note that the figures depict the iteration number, the characteristic values associated with top 5 edge chain sets, and the present scores associated with the select nodes of the top edge chain set. The iteration number 1000 depicts the computed peak scores of the select nodes of the UMG and note that the peak scores scaled by a factor of 1000000. These scores are used in the assessment of the EI associated with the UMG.

Thus, a system and method for influence based structural analysis of a university is disclosed. Although the present invention has been described particularly with reference to the figures, it will be apparent to one of the ordinary skill in the art that the present invention may appear in any number of systems that perform influence based structural analysis. It is further contemplated that many changes and modifications may be made by one of ordinary skill in the art without departing from the spirit and scope of the present invention.

We claim:

1. A system for structural analysis of a university to determine a plurality of assessments of said university at a plurality of levels, wherein said university comprises of a plurality of entities and said plurality of levels comprises of an element level and a component level, said system comprises:
means for obtaining of a university model graph of said university, wherein said university model graph comprises of a plurality of abstract nodes, a plurality of nodes, a plurality of abstract edges, and a plurality of edges, with each abstract node of said plurality of abstract nodes corresponding to an entity of said plurality of entities and each abstract node of said plurality of abstract nodes is associated with a model of a plurality of models, and a node of said plurality of nodes is connected to an abstract node of said plurality of abstract nodes through an abstract edge of said plurality of abstract edges, wherein said node represents an instantiation of an entity associated with said abstract node and said node is associated with an instantiated model, a base score, a present score, and a peak score, wherein said instantiated model is based on a model associated with said abstract node, and said base score is computed based on said instantiated model and is a value between 0 and 1, and a source node of said plurality of nodes is connected to a destination node of said plurality of nodes by a directed edge of said plurality of edges and said directed edge is associated with an influence factor, wherein said influence factor is a value between −1 and +1; (Refer to FIGS. 2, 2a, 2b, 3, and 4)
means for constructing a plurality of edge chains based on said university model graph;
means for performing of epsilon propagation based on said university model graph and said plurality of edge chains;
means for performing of core iteration based on said epsilon propagation and said plurality of edge chains;
means for determining of a characteristic value of a plurality of characteristic values based on said plurality of edge chains;
means for computing of a plurality of peak scores associated with said plurality of nodes of said university model graph based on said plurality of characteristic values; and
means for determining of said plurality of assessments based on said plurality of peak scores.
(BASED ON FIGS. 6, 6a, and 6b)

2. The system of claim 1, wherein said means for constructing of said plurality of edge chains further comprises:
means for obtaining of said plurality of edges associated with said university model graph;
means for selecting an edge randomly from said plurality of edges;
means for making said a part of an edge chain;
means for removing of said edge from said plurality of edges;
means for determining of a plurality of random edges based on said plurality of edges;
means for making of said plurality of random edges a part of said edge chain; and
means for making of said edge chain a part of said plurality of edge chains.
(BASED ON STEP 3 of FIG. 5)

3. The system of claim 2, wherein said means for determining further comprises:
means for selecting an edge randomly from said plurality of edges;
means for removing of said edge from said plurality of edges; and
means for making of said edge a part of said plurality of random edges.
(BASED ON STEP 3 of FIG. 5)

4. The system of claim 1, wherein said means for performing of epsilon propagation further comprises:
means for obtaining of an edge chain randomly from said plurality of edge chains;
means for selecting an edge from said edge chain, wherein an influence factor associated with said edge is greater than a pre-defined threshold;
means for updating of said influence factor associated with said edge from said edge chain based on said pre-defined threshold;
means for determining of a node 1 of said plurality of nodes based on said edge, wherein said node 1 is the source node associated with said edge;
means for determining of a node 2 of said plurality of nodes based on said edge, wherein said node 2 is the destination node associated with said edge;
means for determining of an epsilon based on the value of said influence factor and said pre-defined threshold;
means for obtaining of a function associated with said edge;
means for obtaining of a present score 1 associated with said node 1;
means for obtaining of a present score 2 associated with said node 2;
means for updating of said present score 2 based on said function, said present score 1, said present score 2, and said epsilon;
means for performing of edge chain epsilon propagation; and
means for performing of edge chains epsilon propagation.
(BASED ON STEP 4 of FIG. 5)

5. The system of claim 4, wherein said means for performing of edge chain epsilon propagation further comprises:
means for selecting a next edge from said edge chain, wherein an influence factor associated with said next edge is greater than a pre-defined threshold;
means for updating of said influence factor associated with said next edge from said edge chain based on said pre-defined threshold;
means for determining of a node 1 of said plurality of nodes based on said next edge, wherein said node 1 is the source node associated with said next edge;
means for determining of a node 2 of said plurality of nodes based on said next edge, wherein said node 2 is the destination node associated with said next edge;
means for determining of an epsilon based on the value of said influence factor and said pre-defined threshold;
means for obtaining of a function associated with said next edge;
means for obtaining of a present score 1 associated with said node 1;
means for obtaining of a present score 2 associated with said node 2; and
means for updating of said present score 2 based on said function, said present score 1, said present score 2, and said epsilon.
(BASED ON STEP 4 of FIG. 5)

6. The system of claim 4, wherein said means for performing of edge chains epsilon propagation further comprises:
means for obtaining of a next edge chain randomly from said plurality of edge chains; and
means for performing of edge chain epsilon propagation based on said next edge chain.
(BASED ON STEP 4 of FIG. 5)

7. The system of claim 1, wherein said means for performing of core iteration further comprises:
means for obtaining of said university model graph;
means for constructing of a plurality of edge chains based on said university model graph;
means for obtaining of said plurality of edge chains;
means for determining of an edge chain of said plurality of edge chains;
means for performing of epsilon propagations based on said university model graph and said edge chain.
(BASED ON STEP 5 of FIG. 5a)

8. The system of claim 7, wherein said means for performing of epsilon propagations further comprises:
means for obtaining of said edge chain;
means for obtaining an edge of said edge chain, wherein an influence factor associated with said edge exceeds a pre-defined threshold; and
means for performing of said epsilon propagation based on said edge chain.
(BASED ON STEP 5 of FIG. 5a)

9. The system of claim 1, wherein said means for determining of said characteristic value further comprises:
means for obtaining of said university model graph;
means for obtaining of said plurality of edge chains;
means for determining a plurality of present scores based on said university model graph and said plurality of edge chains, wherein each of said plurality of present scores is associated with a present score of a node of said plurality of nodes of said university model graph with respect to said plurality of edge chains; and
means for computing of said characteristic value based on said plurality of present scores.
(BASED ON STEP 6 of FIG. 5a)

10. The system of claim 1, wherein said means for computing of said plurality of peak scores further comprises:
means for obtaining of said university model graph;
means for determining of a plurality of edge chain sets based on said university model graph;
means for performing of core iterations based on said university model graph and said plurality of edge chain sets;
means for computing of said plurality of characteristic values based on said plurality of edge chain sets;
means for arranging of said plurality of edge chain sets based on said plurality of characteristic values resulting in a plurality of arranged edge chain sets;
means for selecting of top pre-defined number of edge chain sets from said plurality of arranged edge chain sets resulting in a plurality of parent edge chain sets;
means for generating of a plurality of offspring edge chain sets based on said plurality of parent edge chain sets;
means for combining of said plurality of parent edge chain sets and said plurality of offspring edge chain sets resulting in a plurality of next generation edge chain sets;
means for performing of core iterations based on said university model graph and said plurality of next generation edge chain sets;
means for computing of a next iteration characteristic values based on said plurality of next generation edge chain sets; and
means for computing of said plurality of peak scores based on said next iteration characteristic values and said characteristic values.
(BASED ON FIG. 6)

11. The system of claim 10, wherein said means for determining of said plurality of edge chain sets further comprises:
means for constructing of a plurality of edge chains based on said university model graph; and
means for making of said plurality of edge chains a part of said plurality of edge chain sets.
(BASED ON STEP 2 of FIG. 6)

12. The system of claim 10, wherein said means for performing of core iterations further comprises:
means for obtaining of said plurality of edge chain sets;
means for obtaining an edge chain set of said plurality of edge chain sets, wherein said edge chain set comprises of a plurality of edge chains; and
means for performing of core iteration based on said university model graph and said plurality of edge chains.
(BASED ON STEP 3 and STEP 3a of FIG. 6)

13. The system of claim 10, wherein said means for computing of said plurality of characteristic values further comprises:
means for obtaining an edge chain set of said plurality of edge chain sets, wherein said edge chain set comprises of a plurality of edge chains; and
means for determining of a characteristic value of said plurality of characteristic values based on said plurality of edge chains.
(BASED ON STEP 3 and STEP 3b of FIG. 6)

14. The system of claim 10, wherein said means for generating of said plurality of offspring edge chain sets further comprises:
means for obtaining of a parent edge chain set based on said plurality of parent edge chain sets, wherein said parent edge chain set comprises of a plurality of edge chains;
means for determining of a number of edge chains in said plurality of edge chains;
means for generating of a plurality of edge chain random numbers based on said number of edge chains;
mean for obtaining of a random number based on said plurality of edge chain random numbers;
means for selecting of an edge chain based on said plurality of edge chains and said random number;
means for determining of a number of edges in said edge chain;
means for generating of a plurality of edge random numbers based on said number of edges, wherein said plurality of edge random numbers is even;
means for obtaining a pair of random numbers based on said plurality of edge random numbers;
means for obtaining of a first edge based on a first number of said pair of random numbers and said edge chain;
means for obtaining of a second edge based on said a second number of said pair of random numbers and said edge chain;
means for swapping of said first edge and said second edge in said edge chain resulting in a modified edge chain;
means for making of said modified edge chain a part of a modified edge chain set;
means for making of said modified edge chain set a part of a modified edge chain sets; and
means for making of said modified edge chain sets a part of said plurality of offspring edge chain sets.
(BASED ON STEP 5 and STEP 6 of FIG. 6)

15. The system of claim 1, wherein said means for determining of said plurality of assessments further comprises:
means for obtaining of an entity of said plurality of entities;
means for determining of a plurality of instantiated entities of said entity based on said university model graph;
means for determining of a plurality of instantiated entity nodes of said plurality of nodes based on said plurality of instantiated entities;
means for determining of a plurality of instantiated entity peak scores based on said plurality of peak scores and said plurality of instantiated entity nodes; and
means for determining of an assessment of said plurality of assessments associated with said entity based on said plurality of instantiated entity peak scores.
(BASED ON STEP 2 and STEP 3 of FIG. 6b)

16. The system of claim 15, wherein said means for determining of said plurality of assessments further comprises:
means for obtaining of an instantiated entity;
means for determining of an entity associated with said instantiated entity based on said university model graph;
means for obtaining of an instantiated entity node associated with said instantiated entity based on said plurality of nodes;
means for determining of an instantiated entity peak score associated with said instantiated entity node based on said plurality of peak scores;
means for determining of a plurality of instantiated entities of said entity based on said university model graph;
means for determining of a plurality of instantiated entity nodes of said plurality of nodes based on said plurality of instantiated entities;
means for determining of a plurality of instantiated entity peak scores based on said plurality of peak scores and said plurality of instantiated entity nodes; and
means for determining of an assessment of said plurality of assessments associated with said instantiated entity based on said instantiated entity peak score and said plurality of instantiated entity peak scores.
(BASED ON STEP 4 and STEP 5 of FIG. 6)
